(19) United States
(12) Patent Application Publication
(10) Pub. No.: US 2016/0077670 A1
(43) Pub. Date: Mar. 17, 2016

(54) SYSTEM WITH PROJECTOR UNIT AND COMPUTER

(71) Applicant: HEWLETT-PACKARD DEVELOPMENT COMPANY, L.P., Houston, TX (US)

(72) Inventor: David Bradley Short, San Diego, CA (US)

(21) Appl. No.: 14/888,051

(22) PCT Filed: Jul. 31, 2013
(86) PCT No.: PCT/US2013/052873

§ 371 Date: Oct. 29, 2015

(51) Int. Cl. G06F 3/042; G06F 3/16; G06F 3/0354

(52) U.S. Cl. CPC G06F 3/0425; G06F 3/03545; G06F 3/167; G06F 2203/04103

(57) ABSTRACT

An example system, including a support structure further including a base, an upright member extending upward from the base, and a cantilevered top extending outward from the upright member. In addition, the system includes a projector unit attachable to the upright member. Further, the system includes an all-in-one computer attachable to the projector unit. Still further, the system includes a touch sensitive mat communicatively coupled to the ail-in-one computer. The cantilevered top includes a fold mirror, and a camera communicatively coupled to the all-in-one computer, and the projector unit is to project an image upward to reflect off the mirror and on to the touch sensitive mat.

### BACKGROUND

Computer systems typically employ a d splay or multiple displays which are mounted on a support stand and/or are incorporated into some other component of the computer system. For displays employing touch sensitive technology (e.g., touch screens), it is often desirable for a user to interact directly with such displays in order to fully utilize such touch technology during system operations. However, optimum ergonomic placement of a display for simply viewing an image thereon is often at odds with such placement for engaging in touch interaction therewith. Thus, users desiring to use a single computer system for both traditional viewing applications as well as touch interactive application often encounter difficulties in positioning and/or utilizing such systems.

### BRIEF DESCRIPTION OF THE DRAWINGS

For a detailed description of various examples, reference will now be made to the accompanying drawings in which:

FIG. 1 is a schematic perspective view of an example of a computer system in accordance with the principles disclosed herein;

FIG. 2 is another schematic perspective view of the computer sys of FIG. 1 in accordance with the principles disclosed herein;

FIG. 3 is a schematic side view of the computer system of FIG. 1 in accordance with the principles disclosed herein;

FIG. 4 is a schematic front view of the computer system of FIG. 1 in accordance with the principles disclosed herein;

FIG. 5 is a schematic side view of the computer system of FIG. 1 during operation in accordance with the principles disclosed herein;

FIG. 6 is a schematic front view of the system of FIG. 1 during operation in accordance with the principles disclosed herein;

FIG. 7 is a black box circuit diagram of the computer system of FIG. 1 in accordance with the principles disclosed herein; and

FIG. 8 is a schematic perspective view of a virtual collaborative workstation created using a pair of example computer systems in accordance with the principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection. As used herein the term “approximately” means plus or minus 10%. In addition, as used herein, the phrase “user input device” refers to any suitable device for providing an input, by a user, into an electrical system such as, for example, a mouse, keyboard, a hand (or any finger thereof) a stylus, a pointing device, etc.

### DETAILED DESCRIPTION

The following discussion is directed to various examples of the disclosure. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example,

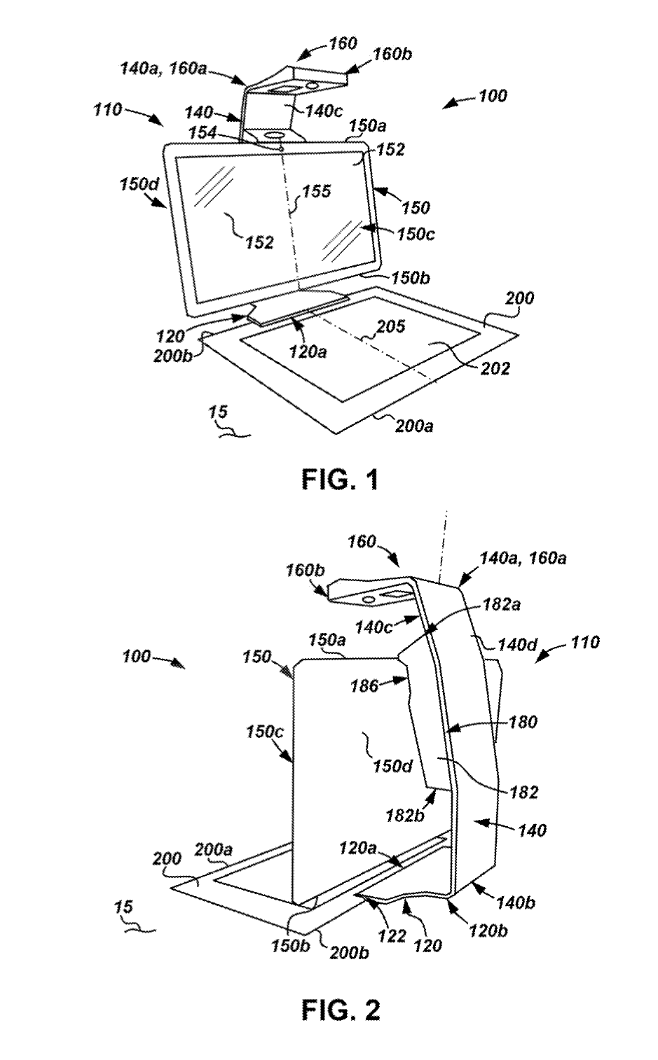

Referring now to FIGS. 1-4, a computer system 180 in accordance with the principles disclosed herein is shown. In this example, system 100 generally comprises a support structure 110, a computing device 150, a projector unit 180, and a touch sensitive mat 200. Computing device 150 may comprise any suitable computing device while still complying with the principles disclosed herein. For example, in some implementations, device 150 may comprise an electronic display, a smartphone, a tablet, an all-in-one computer (i.e., a display that also houses the computer's board), or some combination thereof. In this example, device 150 is an all-in-one computer that includes a central axis or center line 155, first or top side 150a, a second or bottom side 150b axially opposite the top side 150a, a front side 150c extending axially between the sides 150a, 150b, a rear side also extending axially between the sides 150a, 150b and generally radially opposite the front side 150c, A display 152 defines a viewing surface and is disposed along the front side 150c to project images for viewing and interaction by a user (not shown). In some examples, display 152 includes touch sensitive technology such as, for example, resistive, capacitive, acoustic wave, infrared (IR), strain gauge, optical, acoustic pulse recognition, or some combination thereof. Therefore, throughout the following description, display 152 may periodically be referred to as a touch sensitive surface or display. In addition, in some examples, device 15 further includes a camera 154 that is to take images of a user while he or she is positioned in front of display 152. In some implementations, camera 154 is a web camera. Further, in some examples, device 150 also includes a microphone or similar device that is arranged to receive sound inputs (e.g., voice) from a user during operation.

Referring still to FIGS. 1-4, support structure 110 includes a base 120, an upright member 140, and a top 160. Base 120 includes a first or front end 120a, and a second or rear end 120b. During operation, base 120 engages with a support surface 15 to support the weight of at least a portion of the components (e.g., member 140, unit 180, device 150, top 160, etc.) of system 100 during operation. In this example, front end 120a of base 120 includes a raised portion 122 that is slightly separated above the support surface 15 thereby creating a space or clearance between portion 122 and surface 15. As will be explained in more detail below, during operation of system 100, one side of mat 200 is received within the space formed between portion 122 and surface 15 to ensure proper alignment of mat 200. However, it should be appreciated that in other examples, other suitable alignments methods or devices may be used while still complying with the principles disclosed herein.

Upright member 140 includes a first or upper end 140a, a second or lower end 140b opposite the upper end 140a, a first or front side 140c extending between the ends 140a, 140b, and a second or rear side 140d opposite the front side 140c and also extending between the ends 140a, 140b. The lower end 140b of member 140 is coupled to the rear end 120b of base 120, such that member 140 extends substantially upward from the support surface 15.

Top 160 includes a first or proximate end 160a, a second or distal end 160b opposite the proximate end 160a, a top surface 160c extending between the ends 160a, 160b, and a bottom surface 160d opposite the top surface 160c and also extending between the ends 160a, 160b. Proximate end 160a of top 160 is coupled to upper end 140a of upright member 140 such that distal end 160b extends outward therefrom. As a result, in the example shown in FIG. 2, top 160 is supported only at end 160a and thus is referred to herein as a “cantilevered” top. In some examples, base 120, member 140, and top 160 are all monolithically formed; however, it should be appreciated that in other example, base 120, member 140, and/or top 160 may not be monolithically formed while still complying with the principles disclosed herein.

Referring still to FIGS. 1-4, mat 200 includes a central axis or centerline 205, a first or front side 200a, and a second or rear side 200b axially opposite the front side 200a, In this example, a touch sensitive surface 202 is disposed on mat 200 and is substantially aligned with the axis 205. Surface 202 may comprise any suitable touch sensitive technology for detecting and tracking one or multiple touch inputs by a user in order to allow the user to interact with software being executed by device 150 or some other computing device (not shown). For example, in some implementations, surface 202 may utilize known touch sensitive technologies such as, for example, resistive, capacitive, acoustic wave, infrared, strain gauge, optical, acoustic pulse recognition, or some combination thereof while still complying with the principles disclosed herein. In addition, in this example, surface 202 extends over only a portion of mat 200; however, it should be appreciated that in other examples, surface 202 may extend over substantially all of mat 200 while still complying with the principles disclosed herein.

During operation, mat 200 is aligned with base 120 of structure 110, as previously described to ensure proper alignment thereof. In particular, in this example, rear side 200b of mat 200 is placed between the raised portion 122 of base 120 and support surface 15 such that rear end 200b is aligned with front side 120a of base, thereby ensuring proper overall alignment of mat 200, and particularly surface 202, with other components within system 100. In some examples, mat 200 is aligned with device 150 such that the center line 155 of device 150 is substantially aligned with center line 205 of mat 200; however, other alignments are possible. In addition, as will be described in more detail below, in at least some examples surface 202 of mat 200 and device 150 are electrically coupled to one another such that user inputs received by surface 202 are communicated to device 150. Any suitable wireless or wired electrical coupling or connection may be used between surface 202 and device 150 such as, for example, WI-FI BLUETOOTH®, ultrasonic, electrical cables, electrical leads, electrical spring-loaded pogo pins with magnetic holding force, or some combination thereof, while still complying with the principles disclosed herein. In this example, exposed electrical contacts disposed on rear side 200b of mat 200 engage with corresponding electrical pogo-pin leads within portion 122 of base 120 to transfer signals between device 150 and surface 202 during operation. In addition, in this example, the electrical contacts are held together by adjacent magnets located in the clearance between portion 122 of base 120 and surface 5, previously described, to magnetically attract and hold (e.g., mechanically) a corresponding ferrous and/or magnetic material disposed along rear side 200b or mat 200.

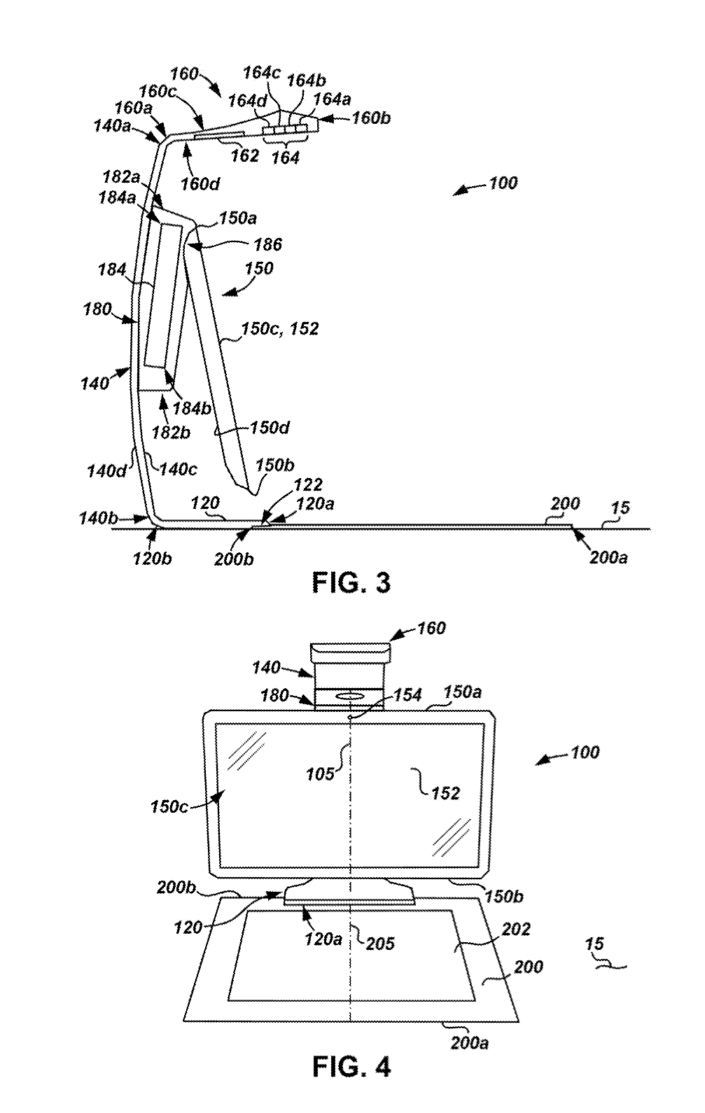

Referring specifically now to FIG. 3, projector unit 180 comprises an outer housing 182, and a projector assembly 184 disposed within housing 182. Housing 182 includes a first or upper end 182a, a second or lower end 182b opposite the upper end 182a, and an inner cavity 183. In this embodiment, housing 182 further includes a coupling or mounting member 186 to engage with and support device 150 during operations. In general member 186 may be any suitable member or device for suspending and supporting a computer device (e.g., device 150) while still complying with the principles disclosed herein For example, in some implementations, member 186 comprises hinge that includes an axis of rotation such that a user (not shown) may rotate device 150 about the axis of rotation to attain an optimal viewing angle therewith. Further, in some examples, device 150 is permanently or semi-permanently attached to housing 182 of unit 180. For example, in some implementations, the housing 180 and device 150 are integrally and/or monolithically formed as a single unit.

Thus, referring briefly to FIG. 4, when device 150 is suspended from structure 110 through the mounting member 186 on housing 182, projector unit 180 (i.e., both housing 182 and assembly 184) is substantially hidden behind device 150 when system 100 is viewed from a viewing surface or viewing angle that is substantially facing display 152 disposed on front side 150c of device 150. In addition, as is also shown in FIG. 4, when device 150 is suspended from structure 110 in the manner described, projector unit 180 (i.e., both housing 182 and assembly 184) and any image projected thereby is substantially aligned or centered with respect to the center line 155 of device 150.

Projector assembly 184 is generally disposed within cavity 188 of housing 182, and includes a first or upper end 184a, a second or lower end 184b opposite the upper end 184a. Upper end 184a is proximate upper end 182a of housing 182 while lower end 184b is proximate lower end 182b of housing 182. Projector assembly 184 may comprise any suitable digital light projector assembly for receiving data from a computing device (e.g., device 150) and projecting an image or images (e.g., out of upper end 184a) that correspond with that input data. For example, in some implementations, projector assembly 184 comprises a digital light processing (DLP) projector or a liquid crystal on silicon (LCoS) projector which are advantageously compact and power efficient projection engines capable of multiple display resolutions and sizes, such as, for example, standard XGA (1024×768) resolution 4:3 aspect ratio or standard WXGA (1280×800) resolution 16:10 aspect ratio. Projector assembly 184 is further electrically coupled to device 150 in order to receive data therefrom for producing light and images from end 184a during operation. Projector assembly 84 may be electrically coupled to device 150 through any suitable type of electrical coupling while still complying with the principles disclosed herein. For example, in some implementations, assembly 184 is electrically coupled to device 150 through an electric conductor, WI-FI, BLUETOOTH®, an optical connection, an ultrasonic connection, or some combination thereof. In this example, device 150 is electrically coupled to assembly 184 through electrical leads or conductors (previously described) that are disposed within mounting member 186 such that when device 150 is suspended from structure 110 through member 186, the electrical leads disposed within member 186 contact corresponding leads or conductors disposed on device 150.

Referring still to FIG. 3, top 160 further includes a fold mirror 162 and a sensor bundle 164. Mirror 162 includes a highly reflective surface 162a that is disposed along bottom surface 160d of top 160 and is positioned to reflect images and/or light projected from upper end 184a of projector assembly 184 toward mat 200 during operation. Mirror 162 may comprise any suitable type of mirror or reflective surface while still complying with the principles disclosed herein. In this example, fold mirror 162 comprises a standard front surface vacuum metalized aluminum coated glass mirror that acts to fold light emitted from assembly 184 down to mat 200. In other examples, mirror 162 could have a complex aspherical curvature to act as a reflective lens element to provide additional focusing power or optical correction.

Sensor bundle 164 includes a plurality of sensors and/or cameras to measure and/or detect various parameters occurring on or near mat 200 during operation. For example, in the specific implementation depicted in FIG. 3, bundle 164 includes an ambient light sensor 164a, a camera (e.g., a color camera) 164b, a depth sensor or camera 164c, and a three dimensional (3D) user interface sensor 164d, Ambient light sensor 164a is arranged to measure the intensity of light of the environment surrounding system 100, in order to, in some implementations, adjust the camera's and/or sensor's (e.g., sensors 164a, 164b, 164c, 164d) exposure settings, and/or adjust the intensity of the light emitted from other sources throughout system such as, for example, projector assembly 184, display 152, etc. Camera 164b may, in some instances, comprise a color camera which is arranged to take either a still image or a video of an object and/or document disposed on mat 200. Depth sensor 164c generally indicates when a 3D object is on the work surface. In particular, depth sensor 164c may sense or detect the presence, shape, contours, motion, and/or the 3D depth of an object (or specific feature(s) of an object) placed on mat 200 during operation. Thus, in some implementations, sensor 164c may employ any suitable sensor or camera arrangement to sense and detect a 3D object and/or the depth values of each pixel (whether infrared, color, or other) disposed in the sensor s field-of-view (FOV). For example, in some implementations sensor 164c may comprise a single infrared (IR) camera sensor with a uniform flood of IR light, a dual IR camera sensor with a uniform flood of IR light, structured light depth sensor technology, time-of-flight (TOF) depth sensor technology, or some combination thereof. User interface sensor 164d includes any suitable device or devices (e.g., sensor or camera) for tracking a user input device such as, for example, a hand, stylus, pointing device, etc. In some implementations, sensor 164d includes a pair of cameras which are arranged to stereoscopically track the location of a user input device (e.g., a stylus) as it is moved by a user about the matt 200, and particularly about surface 202 of mat 200. In other examples, sensor 164d may also or alternatively include an infrared camera(s) or sensor(s) that is arranged to detect infrared light that is either emitted or reflected by a user input device. It should further he appreciated that bundle 164 may comprise other sensors and/or cameras either in lieu of or in addition to sensors 164a, 164b, 164c, 164d, previously described. In addition, as will explained in more detail below, each of the sensors 164a, 164b, 164c, 164d within bundle 164 is electrically and communicatively coupled to device 150 such that data generated within bundle 164 may be transmitted to device 150 and commands issued by device 150 may be communicated to the sensors 164a, 164b, 164c. 164d during operations. As is explained above for other components of system 100, any suitable electrical and/or communicative coupling may be used to couple sensor bundle 164 to device 150 such as for example, an electric conductor. WI-FI, BLUETOOTH®, an optical connection, an ultrasonic connection, or some combination thereof. In this example, electrical conductors are routed from bundle 164, through top 160, upright member 140, and projector unit 180 and into device 150 through the leads that are disposed within mounting member 186, previously described.

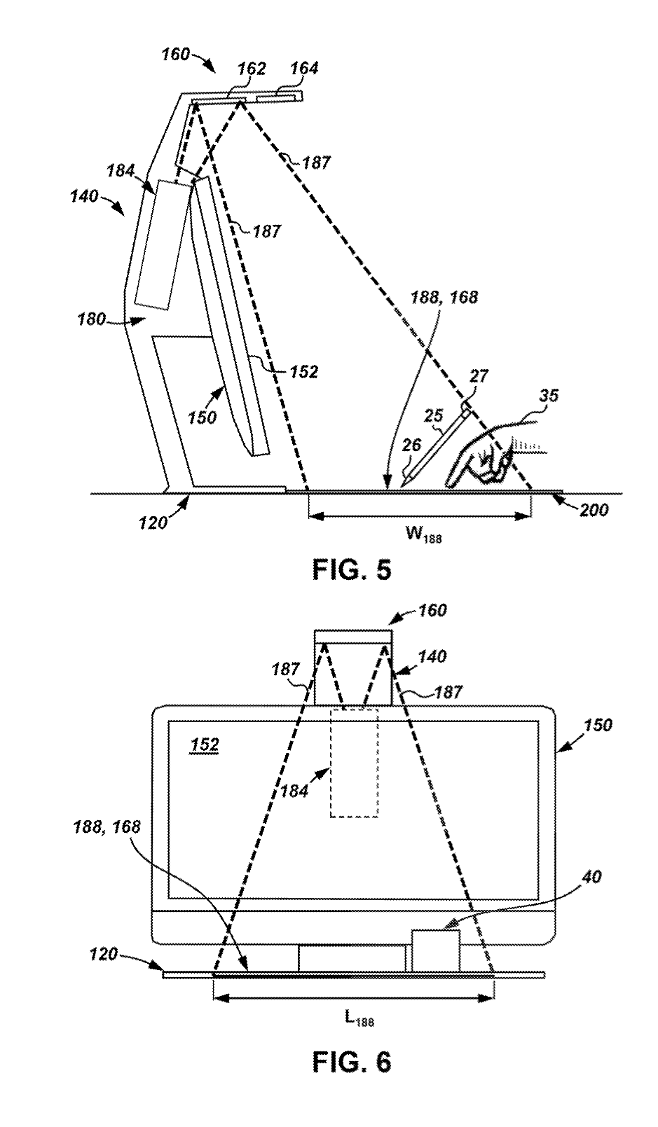

Referring now to FIGS. 5 and 6, during operation of system 100, light 187 is emitted from projector assembly 184, and reflected off of mirror 162 towards mat 200 thereby displaying an image on a projector display space 188. In this example, space 188 is substantially rectangular and is defined by a length L₁₈₈ and a width W₁₈₈. In some examples length L₁₈₈ may equal approximately 16 inches, while width W₁₈₈ may equal approximately 12 inches; however, it should be appreciated that other values for both length L₁₈₈ and width W₁₈₈ may be used while still complying with the principles disclosed herein. In addition, the sensors (e.g., sensors 164a, 164b, 164c, 164d) within bundle 164 include a sensed space 168 that, in at least some examples, overlaps and/or corresponds with projector display space 188, previously described. Space 168 defines the area that the sensors within bundle 164 are arranged to monitor and/or detect the conditions thereof in the manner previously described. In some examples, both space 188 and space 168 coincide or correspond with surface 202 of mat 200, previously described, to effectively integrate the functionality of the touch sensitive surface 202, projector assembly 184, and sensor bundle 164 within a defined area.

Referring now to FIGS. 5-7, in some examples, device 150 directs assembly 184 to project an image onto surface 202 of mat 200. In addition, device 150 may also display an image on the display 152 (which may or may not be the same as the image projected onto surface 202 by assembly 184). The image projected by assembly 184 may comprise information and/or images produced by software executing within device 150. A user (not shown) may then interact with the image displayed on surface 202 and display 152 by physically engaging the touch sensitive surface 202 of mat 200. Such interaction may take place through any suitable method such as, direct interaction with a user's hand 5, through a stylus 25, or other suitable user input device(s).

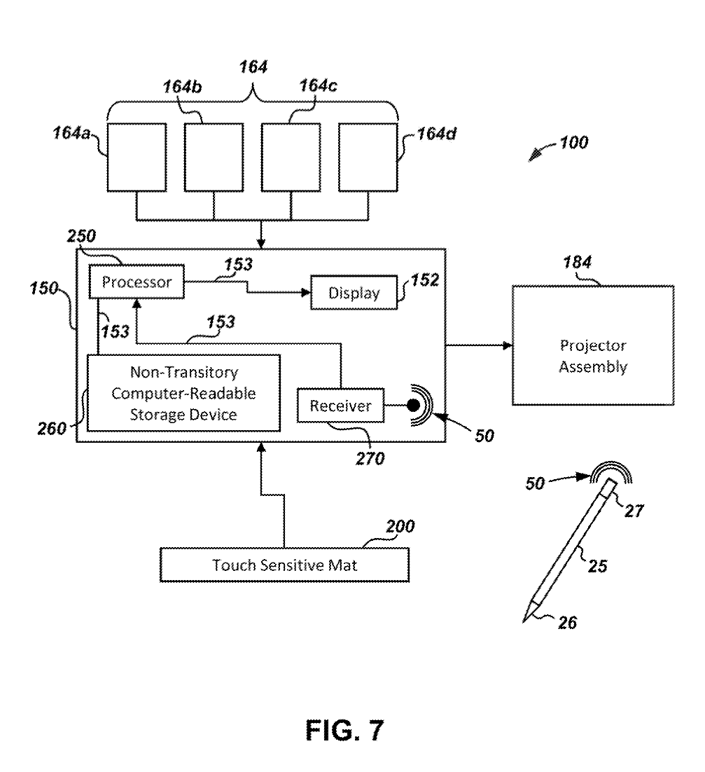

As best shown in FIG. 7, when a user interacts with surface 202 of mat 200, a signal is generated which is routed to device 150 through any of the electrical coupling methods and devices previously described. Once device 150 receives the signal generated within mat 200, it is routed, through internal conductor paths 153, to a processor 250 which communicates with a non-transitory computer-readable storage medium 260 to generate an output signal which is then routed back to projector assembly 184 and/or display 152 to implement a change in the image projected onto surface 202 and/or the image displayed on display 152, respectively. It should also be appreciated that during this process, a user may also be interacting with the image displayed on display 152 through engagement with the touch sensitive surface disposed thereon and/or through another user input device such as, for example, a keyboard and mouse.

In addition, in some examples, stylus 25 further includes a transmitter 27 that is arranged to track the position of stylus 25 (whether or not stylus 25 is interacting with surface 202) and to communicate with a receiver 270 disposed within device 150 through a wireless signal 50. In these examples, input received by receiver 270 from transmitter 27 on stylus 25 is also routed through paths 153 to processor 250 such that an output signal may be generated and routed to the assembly 184 and/or the display 152 as previously described.

Further, in some examples, sensors disposed within bundle 164 (e.g., sensors 164a, 164b, 164c, 164d) may also generate system input which is routed to device 150 for further processing by processor 250 and device 260. For example, in some implementations, sensors within bundle 164 may sense the location and/or presence of a user's hand 35 or stylus 25 and then generate an input signal which is routed to processor 250. Processor 250 then generates a corresponding output signal which is routed to display 152 and/or projector assembly 184 in the manner described above. In particular, in some implementations, bundle 164 includes a pair of cameras or sensors that are arranged to perform stereoscopic stylus tracking (e.g., of stylus 25). In still other implementations, stylus 25 includes a tip 26 that is coated in an infrared retro-reflective coating (e.g., paint), thus allowing it to serve as an infrared retro-reflector. Bundle 164 (and more particularly sensors 164c or 164d) may then further include infrared cameras or sensors as previously described which detect infrared light that is reflected off of tip 26 of stylus 25 and thus track the location of tip 26 as is moves across surface 202 during operation.

As a result, in some examples, the image projected onto surface 202 by assembly 184 serves as a second or alternative touch sensitive display within system 100. In addition, interaction with the image displayed on surface 202 is further enhanced through use of the sensors (e.g., sensors 164a, 164b, 164c, 164d) disposed within bundle 164 as described above.

Referring still to FIGS. 5-7, in addition, during operation of at least some examples, system 100 may capture a two dimensional (2D) image or create a 3D scan of a physical object such that an image of the object may then be projected onto the surface 202 for further use and manipulation thereof. In particular, in some examples, an object 40 may be placed on surface 202 such that sensors (e.g., camera 164b, depth sensor 164c, etc.) within bundle 164 may detect, for instance, the location, dimensions, and in some instances, the color of object 40, to enhance a 2D image or create a 3D scan thereof. The information gathered by the sensors (e.g., sensors 164b, 164c) within bundle 164 may then be routed to processor 250 which communicates with device 260 as previously described. Thereafter, processor 350 directs projector assembly 184 to project an image of the object 40 onto the surface 202. It should also be appreciated that in some examples, other objects such as documents or photos may also be scanned by sensors within bundle 164 in order to generate an image thereof which is projected onto surface 202 with assembly 184. In addition, in some examples, once an object(s) is scanned by sensors within bundle 164, the background of the image may be optionally, digitally removed within the resulting image projected onto surface 202 (or shown on display 152 of device 150). Thus, in some examples, images of physical objects (e.g., object 40) may be captured, digitized, and displayed on surface 202 during operation to quickly and easily create a digital version of a physical object to allow for further manipulation thereof consistent with the manner described herein.

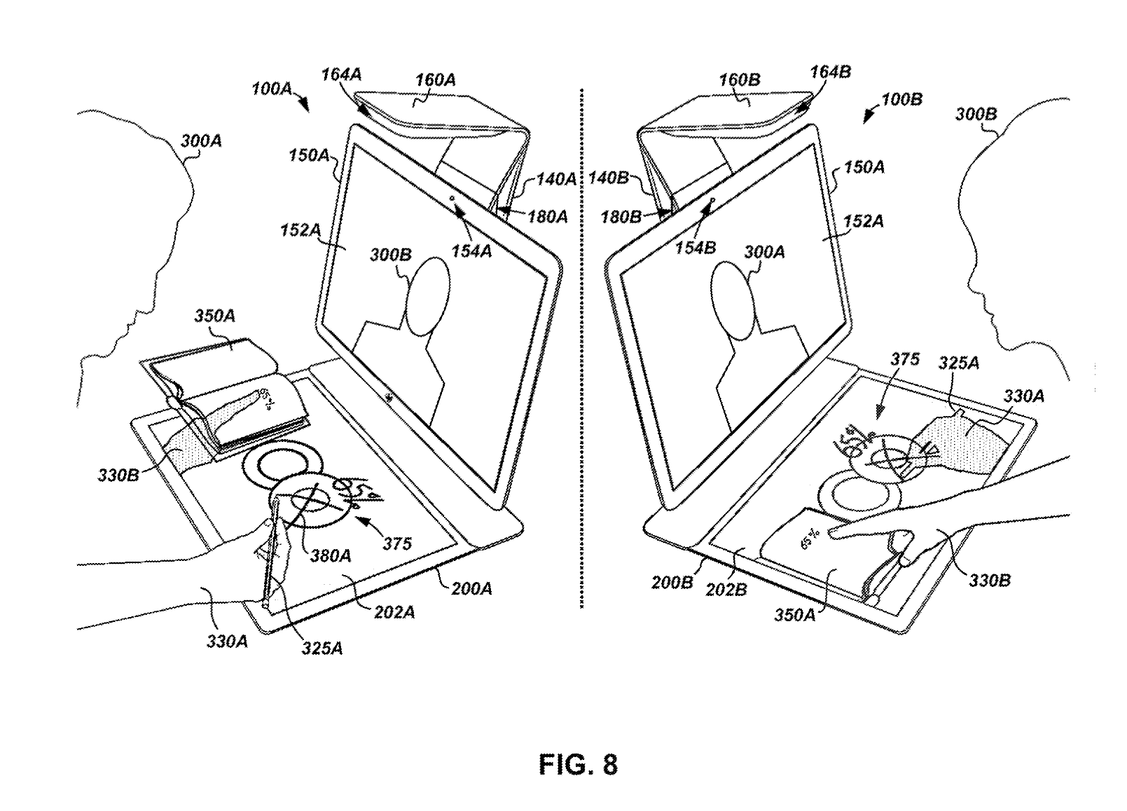

Referring now to FIG. 8, in some examples, system 100 may be used to create a shared digital workspace for collaboration between one or more users. In particular, in the example shown in FIG. 8, a first user 300A is using a first system 100A, while a second user 300B is using a second system 100B. In some examples, user 300A and system 100A may be located remotely from user 300B and system 100B. The systems 100A, 100B are communicatively linked to one another through any suitable connection such as, for example, an electric conductor, BLUETOOTH®, an optical connection, an ultrasonic connection, or some combination thereof, such that information and/or data may pass freely between system 100A, 100B. In addition, each of the systems 100A, 100B are substantially the same as the system 100 previously described and shown in FIGS. 1-7, Therefore, the designation of either “A” or “B” after a given reference numeral only indicates that the particular component or object being referenced belongs to system 100A, 100B, respectively, and is not meant, to alter the description of such components or objections from that previously described above for the system 100.

During collaboration between users 300A, 300B, objects may be placed on the surface 202A or the surface 202B to be scanned in the manner previously described to produce and image on the surface 202A and/or the surface 202B. In particular, in the example shown, a book 350A is partially placed on surface 202A of mat 200A and is scanned by sensors (e.g., sensors 164b, 164c) housed within bundle 164A to create a digital image which is then projected by projector unit 180B of system 160E onto surface 202B in the manner described above. User 300B may interact with the projected image of book 350A on surface 202B by pointing with a hand 330B for other object) at a particular feature of book 350A. The sensors (e.g., sensors 164b, 164c, 164d) within bundle 164B may sense this interaction in the manner previously described and then capture an image or video of hand 330B, which is then projected onto surface 202A of system such that user 300A may view the interaction between hand 330B of user 300B directly on book 350A. In some examples, projector unit 180A of system 100A may also project an image of book 350A onto surface 202A such that user 300A may remove the physical book 350A from surface 202A and may continue to work with the projected image of book 350A on surface 202A. Further, as the above described collaboration is taking place between users 300A, 300B, web camera 154A captures an image of user 300A which is displayed on surface 152B of system 100B for viewing by user 300B, while web camera 154B captures an image of user 300B which is displayed on surface 152A of system 100A for viewing by user 300A in order to further enhance the collaborative experience for each of the users 300A, 300B.

Also, during collaboration between users 300A, 300B, digital content that is generated by software executing on either device 150A and/or device 150B may be displayed on both the surfaces 202A, 202B, via the projector units 180A, 180B respectively, such that both users 300A, 300B may each view and interact with the shared digital content in a cooperative fashion. In particular, in the example shown, a graphic 375 (i.e., digital content) is displayed on both surfaces 202A, 202B such that both users 300A, 300B may view graphic 375 simultaneously. Thereafter, one of the users 300A, 300B, in this case user 300A, physically interacts with graphic 375 using a stylus 325 in order to create a digital marking 378 which is projected onto both the surfaces 202A, 202B for viewing by both users 300A, 300B. Marking 378 may be created on graphic 375 in the manner previously described. For example, in creating marking 378, the position of stylus 25 may be tracked with sensors (e.g., sensor 164d) disposed within bundle 164, wireless signals 50 received from transmitter 27, and/or direct interaction between tip 26 of stylus 25 and the touch sensitive surface 202. Therefore, through use of system 100A, 100B users 300A, 300B may more effectively share information through a digital collaborative workspace.

In the manner described, through use of examples of a computer system 100 in accordance with the principles disclosed herein, an additional touch sensitive display may be projected onto a touch sensitive surface (e.g., surface 202) to provide dual screen capability for a computing device (e.g., device 150). In addition, through use of a computer system 100 in accordance with the principles disclosed herein, a physical object (e.g., object 40) may be scanned thereby creating a digital version of the physical object for viewing and/or manipulation on a display surface of a computing device (e.g., display 152 and/or surface 202). Further, through use of a computer system 100 in accordance with the principles disclosed herein, a digital shared workstation for remotely positioned users (e.g., users 300A, 300B) may be created wherein physical content may be scanned, digitized, and shared among all concurrent users of the digital collaboration workstation, and user interaction with the digital content and/or physical objection is visible by all participants.

While device 150 has been described as an all in-one computer, it should be appreciated that in other examples, device 150 may further employ the use of more traditional user input devices such as, for example, a keyboard and a mouse. In addition, while sensors 164a, 164b, 164c, 164d within bundle 164 have been described as each representing a single sensor or camera, it should be appreciated that each of the sensors 164a, 164b, 164c, 164d may each include multiple sensors or cameras while still complying with the principles described herein. Further, while top 160 has been described herein as a cantilevered top, it should be appreciated that in other examples, top 160 may be supported at more than one point and is thus may not be cantilevered while still complying with the principles disclosed herein.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A system, comprising:
a support structure including a base, an upright member extending upward from the base, and a cantilevered top extending outward from the upright member;
a projector unit attachable to the upright member;
an all-in-one computer attachable to the projector unit; and
a touch sensitive mat communicatively coupled to the all-in-one computer;
wherein the cantilevered top includes a fold mirror, and a camera communicatively coupled to the all-in-one computer; and
wherein the projector unit is to project an image upward to reflect off the mirror and on to the touch sensitive mat.

2. The system of claim 1 wherein the projector unit is coupled to the upright member and substantially hidden by the all-in-one computer when viewed from a viewing surface of the all-in-computer.

3. The system of claim 1 wherein the projected image and the projector unit are substantially centered with respect to a center line of the all-in-one computer.

4. The system of claim 1 wherein, dining a remote collaboration with another system, the all-in-computer is to cause the projector unit to project an image on to the touch sensitive mat, the projected image including an image of physical content received from the other system as well as digital content, the all-in-computer including a display on which a video image from the other system is to be displayed.

5. The system of claim 1 wherein the cantilevered top includes a plurality of cameras, at least one camera of which is used for depth detection and at least two cameras of which are used for stereoscopic stylus tracking.

6. The system of claim 1 wherein the all-in-computer is to cause the camera to scan a physical object on the touch sensitive mat to produce a scanned image and then to cause the projector unit to project the scanned image back on to the touch sensitive mat.

7. The system of claim further comprising an electrical connection between the touch sensitive mat and the all-in-computer through the base.

8. A system, comprising:
a support structure including a base, an upright member extending upward from the base, and a cantilevered top extending outward from the upright member and including a fold mirror and a camera;
a projector unit attachable to the upright member and to project an image upward to reflect off the mirror and on to a surface in front of the base; and
an all-in-one computer attachable to the projector unit;
wherein the all-in-computer is to cause the camera to scan a physical object placed on the surface in front of the base to thereby produce a scanned image, and then to cause the projector unit to project the scanned image back on to the surface in front of the base.

9. The system of claim 8 further comprising a touch sensitive mat communicatively coupled to the all-in-one computer through the base.

10. The system of claim 8 wherein the projected scanned image and the projector unit are substantially centered with respect to the all-in-one computer.

11. The system of claim 8 wherein, during a remote collaboration with another system, the all-in-computer is to cause the projector unit to project a collaboration image on to the surface in front of the base, the projected collaboration image including digital content received from the other system as well as an image of physical content received from the other system the all-in-computer including a display on which a video image from the other system is to be displayed.

12. The system of claim 8 wherein the cantilevered top includes a plurality of cameras, at least one camera of which is used for depth detection and at least two cameras of which are used for stereoscopic stylus tracking.

13. The system of claim 8 wherein the touch sensitive mat is usable with a stylus that includes an infrared (IR) retro-reflector, and the cantilevered top includes an infrared sensor to detect a location of the stylus based on the stylus' IR retro-reflector.

14. A system, comprising:
a support structure including a base, an upright member extending upward from the base, and a cantilevered top extending outward from the upright member;
a projector unit attachable to the upright member;
an all-in-one computer attachable to the projector unit; and
a touch sensitive mat communicatively coupled to the all-in-one computer;
wherein the cantilevered top includes a fold mirror, and a camera communicatively coupled to the all-in-one computer;
wherein, during a remote collaboration with another system, the all-in-computer is to cause the projector unit to project a collaboration image on to the touch sensitive mat, the projected collaboration image including an image of physical content received from the other system as well as digital content, the all-in-computer including a display on which a video image from the other system is to be displayed; and
wherein the projected collaboration image and the projector unit are substantially centered with respect to a center line of the all-in-one computer.

15. The system of claim 14 wherein the all-in-computer is to cause the camera to scan a physical object on the touch sensitive mat to produce a scanned image and then to cause the projector unit to project the scanned image back on to the touch sensitive mat.
